(19) United States
(12) Patent Application Publication
(10) Pub. No.: US 2008/0274701 A1
(43) Pub. Date: Nov. 6, 2008

(54) METHOD AND SYSTEM TO RECONFIGURE A NETWORK TO IMPROVE NETWORK LIFETIME USING MOST RELIABLE COMMUNICATION LINKS

(76) Inventors: Arati Manjeshwar, Chandler, AZ (US); Falk Herrmann, Fairport, NY (US)

Correspondence Address: KENYON & KENYON LLP, ONE BROADWAY, NEW YORK, NY, 10004, US

(21) Appl. No.: 12/175,611

(22) Filed: Jul. 18, 2008

Related U.S. Application Data
(63) Continuation of application No. 11/241,296, filed on Sep. 30, 2005.
Application No. 11/241,296 is a continuation-in-part of application No. 10/301,478, filed on Nov. 21, 2002.

(51) Int. Cl. H04B 17/00; H04L 12/28

(52) U.S. Cl. 455/67.11; 370/254

(57) ABSTRACT

A method and system of enhancing an operational lifetime of a wireless network is provided, which includes monitoring a link quality between node elements of the wireless network, periodically collecting information regarding the link quality between node elements of the wireless network, and reconfiguring a network topology of the wireless network based on the collected information.

### CROSS REFERENCE TO RELATED APPLICATIONS

This application is related to U.S. patent application Ser. No. 11/241,298, filed Sep. 30, 2005; U.S. patent application Ser. No. 11/240,401, filed Sep. 30, 2005; U.S. patent application Ser. No. 11/239,837, filed Sep. 30, 2005; U.S. patent application Ser. No. 11/240,545, filed Sep. 30, 2005; U.S. patent application Ser. No. 11/239,836, filed Sep. 30, 2005; U.S. patent application Ser. No. 11/240,436, filed Sep. 30, 2005; U.S. patent application Ser. No. 11/241,639, filed Sep. 30, 2005; U.S. patent application Ser. No. 11/241,300, filed Sep. 30, 2005; application Ser. No. 11/240,434, filed Sep. 30, 2005. The disclosure of each of the foregoing related applications is hereby incorporated by reference herein in its entirety.

This application is a continuation of and claims priority under 35 U.S.C. § 120 to U.S. patent application Ser. No. 11/241,296, filed Sep. 30, 2005, the disclosure of which is incorporated herein by reference in its entirety.

This application is also a continuation in part of and claims priority under 35 U.S.C. § 120 to U.S. patent application Ser. No. 10/301,478, filed Nov. 21, 2002.

### FIELD OF INVENTION

The present invention relates to a method and system for reconfiguring a communications network, including, for example, a wireless communications network, to improve network lifetime using the most reliable communication links.

### BACKGROUND INFORMATION

In wireless systems, it may be more energy efficient to use reliable links for communication, particularly, when mounting network node elements in ad-hoc wireless communications networks.

Battery operated wireless systems may communicate more if reliable links are used because such links may reduce errors in the communication, lost communications, retries, etc. The quality of the wireless links, however, may change dynamically and may also depend on environmental changes. In particular, the link quality may change significantly over time due to, for example, newly deployed system elements, new systems deployed that use the same wireless channel, or movement of physical obstacles (e.g., furniture or metal cabinets in offices), etc.

The 23^{rd} Conference of the International Electronic and Electrical Engineers (IEEE) Communications Society held in Hong Kong Mar. 7 to 11, 2004 (Infocom 2004) proposed an Optical Orthoganl Codeword (OOC) scheme to gather link quality, for an energy-efficient system in a purportedly very energy-efficient manner.

### SUMMARY OF THE INVENTION

The present invention provides a method and system for reconfiguring a communications network, including, for example, a wireless communications network, to improve network lifetime using the most reliable communication links.

An exemplary embodiment and/or exemplary method of the present invention may periodically update the link quality information of a wireless communications network, and based on this information make changes to the network topology (if required) to improve, enhance and/or prolong the network life.

According to an exemplary embodiment and/or exemplary method of the present invention, certain quality characteristics of the wireless links are collected periodically and the network topology of wireless nodes is changed (if required) so that the most reliable links are used. Consequently, errors in communication may be reduced, lost communications or retransmissions may be minimized, and longer uninterrupted communications may be achieved.

An exemplary embodiment and/or exemplary method of the present invention is directed to a method of enhancing an operational lifetime of a wireless network, the method including monitoring a link quality between node elements of the wireless network, periodically collecting information regarding the link quality between node elements of the wireless network, and reconfiguring a network topology of the wireless network based on the collected information.

Another exemplary embodiment and/or exemplary method of the present invention is directed to a method of enhancing an operational lifetime of a wireless network, in which the information regarding the link quality includes a measured signal strength.

Yet another exemplary embodiment and/or exemplary method of the present invention is directed to a method of enhancing an operational lifetime of a wireless network, in which the information regarding the link quality includes an error rate.

Still another exemplary embodiment and/or exemplary method of the present invention is directed to a method of enhancing an operational lifetime of a wireless network, in which the information regarding the link quality includes an retransmission rate.

Yet another exemplary embodiment and/or exemplary method of the present invention is directed to a method of enhancing an operational lifetime of a wireless network, in which the network topology is reconfigured so that a link quality of an established communication path between the node elements is maximized.

Still another exemplary embodiment and/or exemplary method of the present invention is directed to a method of enhancing an operational lifetime of a wireless network, in which the established communication path is a preferred established communication path.

Yet another exemplary embodiment and/or exemplary method of the present invention is directed to a method of enhancing an operational lifetime of a wireless network, the method including detecting a shift in an adverse environmental condition that affects the link quality between node elements of the wireless network.

Still another exemplary embodiment and/or exemplary method of the present invention is directed to a method of enhancing an operational lifetime of a wireless network, the method including detecting a change in node elements of the wireless network, and updating the collected information based on the detected change in node elements.

Yet another exemplary embodiment and/or exemplary method of the present invention is directed to a method of enhancing an operational lifetime of a wireless network, in which at least one node element of the wireless network is energy constrained.

An exemplary embodiment and/or exemplary method of the present invention is directed to a wireless network, which includes a plurality of network node elements configured to communicate via communication links arranged accordingly to a network topology, an arrangement to monitor a link quality between each of the plurality of network node elements, an arrangement to periodically collect information regarding a link quality of the communication links, and an arrangement to reconfigure the network topology based on the collected information.

Another exemplary embodiment and/or exemplary method of the present invention is directed to a wireless network, in which at least one of the plurality of network elements is battery operated.

Yet another exemplary embodiment and/or exemplary method of the present invention is directed to a wireless network, in which the information regarding the link quality of the communication links include at least one of a measured signal strength, an error rate, and a retransmission rate.

Still another exemplary embodiment and/or exemplary method of the present invention is directed to a wireless network, in which the network topology is reconfigured so that a link quality of an established communication path between the node elements is maximized.

Yet another exemplary embodiment and/or exemplary method of the present invention is directed to a wireless network, in which the established communication path is a preferred established communication path.

Still another exemplary embodiment and/or exemplary method of the present invention is directed to a wireless network, which includes an arrangement to detect a shift in an adverse environmental condition that affects the link quality between at least two of the plurality of network node elements.

Another exemplary embodiment and/or exemplary method of the present invention is directed to a wireless network, which includes an arrangement to detect a change in the plurality of network node elements, and an arrangement to update the collected information based on the detected change of the plurality of network node elements.

An exemplary embodiment and/or exemplary of the present invention is directed to a method of improving an operational aspect of a wireless network, the method including monitoring a reliability of a communication path between each of a plurality of devices of the wireless network, periodically collecting information regarding the reliability of the communication links, and reconfiguring a network topology of the wireless network based on the collected information so that an expected reliability of an established communication path between the plurality of devices is maximized.

### BRIEF DESCRIPTION OF THE DRAWINGS

FIG. 1 shows an exemplary wireless network that includes a base station and seven network nodes, and an adverse environmental condition located within the exemplary wireless network.

FIG. 2 shows an exemplary network topology for the exemplary wireless network of FIG. 1 prior to reconfiguration of network topology, in which the devices of the exemplary wireless network are arranged according to a predetermined preference for communicating with each other.

FIG. 3 shows the exemplary wireless network of FIG. 1 having undergone a change in link quality between network devices, which resulted from a shifting of the adverse environmental condition within the exemplary wireless network.

FIG. 4 shows an exemplary network topology for the exemplary wireless network of FIG. 2, which underwent a reconfiguration to accommodate the change in link quality between the first node and the fifth node, and the change in link quality between the base station and the sixth and seventh nodes.

FIG. 5 shows an exemplary method of enhancing an operational lifetime of the exemplary wireless network of FIG. 1, in which the network topology of the exemplary wireless network is changed to accommodate changing network conditions so that the most reliable links between the nodes are used.

### DETAILED DESCRIPTION

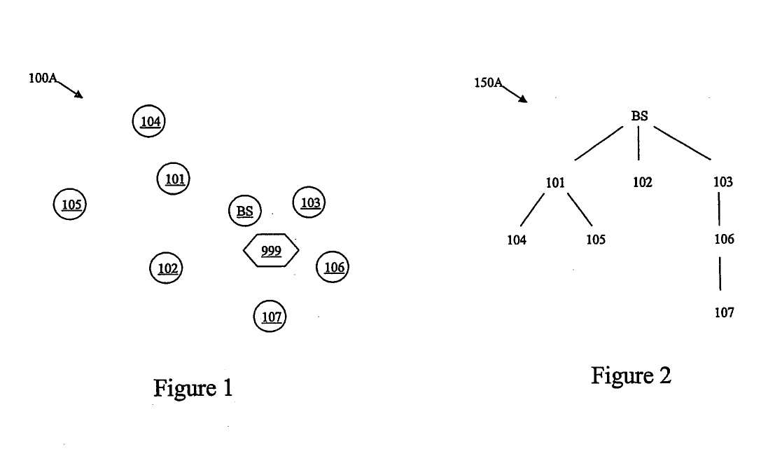

FIG. 1 shows an exemplary wireless network 100, which includes a base station BS, a first node 101, a second node 102, a third node 103, a fourth node 104, a fifth node 105, a sixth node 106, and a seventh node 107. In this regard, the base station BS and seven network nodes 101 through 107 may be referred collectively as the “devices” of the exemplary wireless network 100. Here, it is assumed that at least some of the devices of the exemplary wireless network 100 are capable of communicating with each other, and measuring characteristics of a communications channel between devices. In particular, it is assumed that at least some of the devices of the exemplary wireless network 100 can measure a link quality between the base station BS and neighboring nodes, or between the nodes themselves. It is also assumed that at least some of the devices of the exemplary wireless network 100 are capable of determining a preferred communication path to communicate with other devices.

FIG. 1 further shows an adverse environmental condition 999 existing within the exemplary wireless network 100. In particular, FIG. 1 shows the adverse environmental condition 999 existing between the base station BS and the seventh node 107, and between the base station BS and the sixth node 106, which may prevent the establishment of a reliable link between the base station BS and the seventh node 107 or between the base station BS and the sixth node 106. In this regard, the environmental condition may be, for example, a physical object that blocks the signal path between the base station BS and the seventh node 107, and between the base station BS and the sixth node 106.

FIG. 2 shows an exemplary network topology 150A for the exemplary wireless network 100 of FIG. 1 prior to a reconfiguration of the network topology 150A, in which the devices of the exemplary wireless network 100 are arranged according to predetermined preference for communicating with each other. In particular, the exemplary network topology 150A shows the devices of the exemplary wireless network 100 arranged in a hierarchical manner to indicate a preferred path of communication between the devices. In this regard, a line between two devices indicates that a preferred communications link is established. For example, the line displayed between the base station BS and the first node 101 indicates a preferred communication link is established between the base station BS and the first node 101, and the line displayed between the first node 101 and the fifth node 105 indicates that a preferred communication link is established between the first node 101 and the fifth node 105. Accordingly, if the base station BS and the first node 101 wish to communicate with each other, they simply send a message directly to one another. Likewise, if the first node 101 and the fifth node 105 wish to communicate with each other, they too simply send a message directly to one another.

It is noted, however, that a line is not displayed between the base station BS and the fifth node 105. Accordingly, if the base station BS or the fifth node 105 wish to communicate with each other, they must communicate indirectly via the first node 101. That is, if the base station BS wishes to communicate a message to the fifth node 105, the base station BS sends the message intended for the fifth node 105 to the first node 101 via the preferred communication link established between the base station BS and the first node 101, and the first node 101 upon receiving the message intended for the fifth node 105 forwards the message to the fifth node 105 via the preferred communication link established between the first node 101 and the fifth node 105. Likewise, if the fifth node 105 wishes to communicate a message to the base station BS, the fifth node 105 sends the message intended for the base station BS to the first node 101 via the preferred communication link established between the fifth node 105 and the first node 101, and the first node 101 upon receiving the message intended for the base station BS forwards the message to the base station BS via the preferred communication link established between the first node 101 and the base station BS. Hence, the base station BS and the fifth node 105 do not communicate their messages directly, but rather indirectly via the first node 101. It is noted here that the base station BS and the fifth node 105 communicate indirectly via the first node 101, even if it is possible to established a direct communication link between the base station BS and the fifth node 105, since it has been previously determined that if a communication link were established between the base station BS and the fifth node 105, such a communication link was considered to be unacceptably reliable.

As a further example of the hierarchically arranged network topology 150A indicating the preferred path of communication, the line displayed between the base station BS and the third node 103 indicates that a preferred communication link is established between the base station BS and the third node 103, the line displayed between the third node 103 and the sixth node 106 indicates that a preferred communication link is established between the third node 103 and the sixth node 106, and the line displayed between the sixth node 106 and the seventh node 107 indicates that a preferred communication link is established between the sixth node 106 and the seventh node 107. Accordingly, if the base station BS and the third node 103 wish to communicate with each other, they simply send a message directly to one another. Likewise, if the third node 103 and the sixth node 106 wish to communicate with each other, they too simply send a message directly to one another. Likewise still, if the sixth node 106 and the seventh node 107 wish to communicate with each other, they too simply send a message directly to one another.

It is noted, however, that a line is not displayed between the third node 103 and the seventh node 107, and that a line is not displayed between the base station BS and the sixth node 106 or between the base station BS and the seventh node 107. Accordingly, if the base station BS and the seventh node 107 wish to communicate with each other, they must communicate indirectly via the third node 103 and the sixth node 106. That is, if the base station BS wishes to communicate a message to the seventh node 107, the base station BS sends the message intended for the seventh node 107 to the third node 103 via the preferred communication link established between the base station BS and the third node 103, and the third node 103 upon receiving the message intended for the seventh node 107 forwards the message to the sixth node 106 via the preferred communication link established between the third node 103 and the sixth node 106, and the sixth node 106 upon receiving the message intended for the seventh node 107 forwards the message to the seventh node 107 via the preferred communication link established between the sixth node 106 and the seventh node 107. Likewise, if the seventh node 107 wishes to communicate a message to the base station BS, the seventh node 107 sends the message intended for the base station BS to the sixth node 106 via the preferred communication link established between the seventh node 107 and the sixth node 106, and the sixth node 106 upon receiving the message intended for the base station BS forwards the message to the third node 103 via the preferred communication link established between the sixth node 106 and the third node 103, and the third node 103 upon receiving the message intended for the base station BS forwards the message to the base station BS via the preferred communication link established between the third node 103 and the base station BS. Hence, the base station BS and the seventh node 107 do not communicate their messages directly, but rather indirectly via the third node 103 and the sixth node 106.

It is also noted that the base station BS and the sixth node 106 communicate indirectly via the third node 103, despite the relatively close physical arrangement, due to, for example, the existence of the adverse environmental condition 999 arranged between the base station BS and the sixth node 106, which prevents the establishment of a reliable link between the base station BS and the sixth node 106. Likewise, the base station BS and the seventh node 107 communicate indirectly via the third node 103 and the sixth node 106 despite the relatively close physical arrangement due to, for example, the existence of the same adverse environmental condition 999, which is also arranged between the base station BS and the seventh node 107 and therefore prevents the establishment of a reliable link between the base station BS and the seventh node 107. It is also noted here that the adverse environmental condition 999 may be transitory. That is, the adverse environmental condition 999 may disappear or shift to a new location within the exemplary wireless network 100.

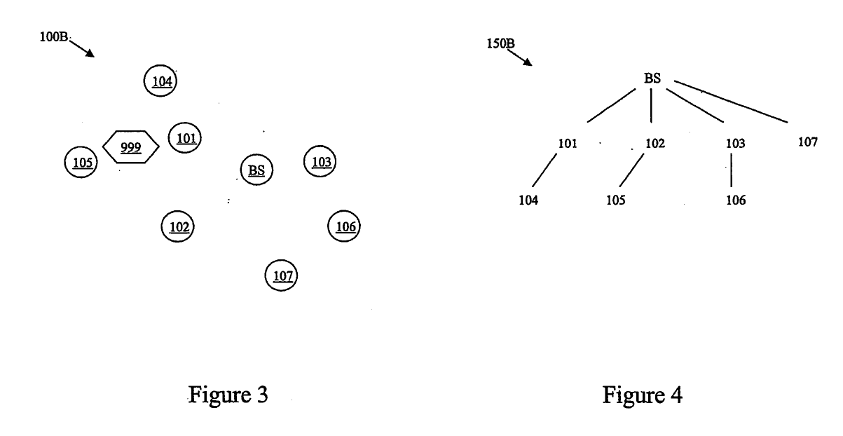

FIG. 3 shows the exemplary wireless network 100 of FIG. 1 having undergone a change in link quality between network devices, which resulted from a shifting of the adverse environmental condition 999 within the exemplary wireless network 100. In particular, the adverse environmental condition 999 shifted from being arranged between the base station BS and the sixth and seventh nodes 106/107 to being arranged between the first node 101 and the fifth node 105, which affected the link quality between the base station BS and the sixth and seventh node 106/107, and also the link quality between the first node 101 and the fifth node 105. In particular, with the change in adverse environmental condition 999, an improved link quality characteristics may be detected between the base station BS and the sixth node 106, and between the base station BS and the seventh node 107. Moreover, with the change in adverse environmental condition 999, poorer link quality characteristics may be detected between the first node 101 and the fifth node 105. In this regard, the change in link quality was detected, for example, by a periodic collection of information regarding certain quality characteristics of the wireless links between the devices so that based on this collected information, the network topology of wireless nodes may be configured such that the most reliable links between the nodes are used.

FIG. 4 shows an exemplary network topology 150B for the exemplary wireless network 100 of FIG. 2, which underwent a reconfiguration to accommodate the change in link quality between the first node 101 and the fifth node 105, and the change in link quality between the base station BS and the sixth and seventh nodes 106/107. In particular, the exemplary network topology 150B also shows that the line previously displayed between the first node 101 and the fifth node 105 is now removed indicating that a preferred communication link is no longer established directly between the first node 101 and the fifth node 105, and that a line was added between the second node 102 and the fifth node 105 indicating that a preferred communication link is now established directly between the second node 102 and the fifth node 105. According, if the base station BS and the fifth node 105 wish to communicate with each other, then must now communicate indirectly via the second node 103 rather than the first node 101. Likewise, the exemplary network topology 150B also shows that the line previously displayed between the sixth node 106 and the seventh node 107 is now removed indicating that a preferred communication link is no longer established directly between the sixth node 106 and the seventh node 107, and that a line was added between the base station BS and the seventh node 107 indicating that a preferred communication link has been established directly between the base station BS and the seventh node 107. Accordingly, if the base station BS and the seventh node 107 wish to communicate with each other, they simply send a message directly to one another, rather than via the third node 103.

It is noted that although the adverse environmental condition 999 no longer exists between the base station BS and the sixth node 106, as shown in FIG. 3, the exemplary network topology 150B has not been reconfigured with respect to the preferred communication relationship between the base station and the sixth node 106. That is, the base station BS and the sixth node 106 do not establish a preferred communication link directly, but rather, continue to communicate indirectly via the third node 103. This is because the removal of the adverse environmental condition 999 between the base station BS and the sixth node 106 does not necessarily mean that a direct communication link between the base station BS and the sixth node 106 is the most reliable link. Rather, another indirect path may still prove to be the most reliable, which in this instance, is the combination of the preferred communication link established between the sixth node 106 and the third node 103, and the preferred communication link established between the third node 103 and the base station BS.

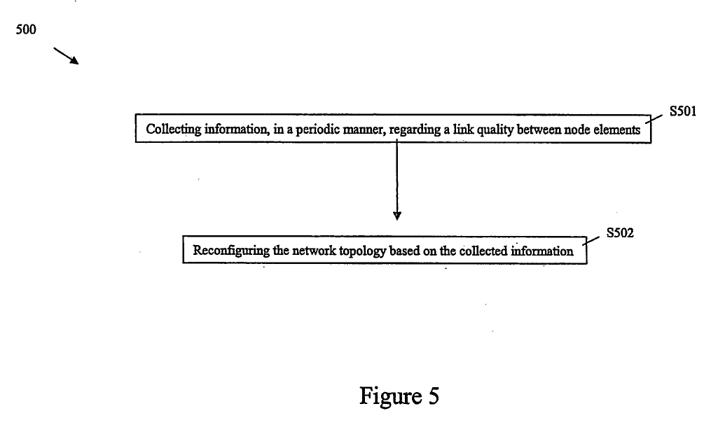

FIG. 5 shows an exemplary method 500 of enhancing an operational lifetime of the exemplary wireless network 100 of FIG. 1, in which the network topology of the exemplary wireless network 100 is changed to accommodate changing network conditions so that the most reliable links between the nodes are used. The following steps S501 to S502 of the exemplary method 500 are described below.

In step S501, information is periodically collected regarding a link quality between the devices of the exemplary wireless network 100. For example, information regarding a link quality between the base station BS and each of the seven network nodes 101 to 107, and/or between the network nodes themselves, is collected periodically and analyzed to determine which links are, or should be, the most reliable, and which links are, or are likely to be, the least reliable.

In step S502, the network topology of the exemplary wireless network 100 is reconfigured based on the collected information. For example, if it is determined from the collected information that a certain link previously considered to be the most reliable now becomes relatively unreliable, due to, for example, a negatively affecting change in an adverse environmental condition, or that a certain link previously considered to be relatively unreliable now becomes the most reliable, due to, for example, a positively affecting change in an adverse environmental condition, the network topology of the exemplary wireless network 100 may be reconfigured to accommodate these changed conditions. In particular, the established preferred communication links may be adjusted to reflect the change in link quality.

What is claimed is:

1. A method of enhancing an operational lifetime of a wireless network, the method comprising:
monitoring a link quality between node elements of the wireless network;
periodically collecting information regarding the link quality between node elements of the wireless network; and
reconfiguring a network topology of the wireless network based on the collected information.

2. The method of claim 1, wherein the information regarding the link quality includes a measured signal strength.

3. The method of claim 1, wherein the information regarding the link quality includes an error rate.

4. The method of claim 1, wherein the information regarding the link quality includes an retransmission rate.

5. The method of claim 1, wherein the network topology is reconfigured so that a link quality of an established communication path between the node elements is maximized.

6. The method of claim 1, wherein the established communication path is a preferred established communication path.

7. The method of claim 1, further comprising:
detecting a shift in an adverse environmental condition that affects the link quality between node elements of the wireless network.

8. The method of claim 1, further comprising:
detecting a change in node elements of the wireless network; and
updating the collected information based on the detected change in node elements.

9. The method of claim 1, wherein at least one node element of the wireless network is energy constrained.

10. A wireless network comprising:
a plurality of network node elements configured to communicate via communication links arranged accordingly to a network topology;
an arrangement to monitor a link quality between each of the plurality of network node elements;
an arrangement to periodically collect information regarding a link quality of the communication links; and
an arrangement to reconfigure the network topology based on the collected information.

11. The wireless network of claim 10, wherein at least one of the plurality of network elements is battery operated.

12. The wireless network of claim 10, wherein the information regarding the link quality of the communication links include at least one of a measured signal strength, an error rate, and a retransmission rate.

13. The wireless network of claim 1, wherein the network topology is reconfigured so that a link quality of an established communication path between the node elements is maximized.

14. The wireless network of claim 1, wherein the established communication path is a preferred established communication path.

15. The wireless network of claim 1, further comprising:
an arrangement to detect a shift in an adverse environmental condition that affects the link quality between at least two of the plurality of network node elements.

16. The wireless network of claim 1, further comprising:
an arrangement to detect a change in the plurality of network node elements; and
an arrangement to update the collected information based on the detected change of the plurality of network node elements.

17. A method of improving an operational aspect of a wireless network, comprising:
monitoring a reliability of a communication path between each of a plurality of devices of the wireless network;
periodically collecting information regarding the reliability of the communication links; and
reconfiguring a network topology of the wireless network based on the collected information so that an expected reliability of an established communication path between the plurality of devices is maximized.

18. The method of claim 1, further comprising:
monitoring a link quality between a base station and the node elements of the wireless network; and
periodically collecting information regarding the link quality between the base station and the node elements of the wireless network.

19. The method of claim 18, wherein the network topology is reconfigured as a hierarchical network topology that includes a preferred established communication path.

20. The method of claim 19, wherein the base station and the node elements reconfigured in the hierarchical network topology communicate at least one of directly and indirectly with each other via the preferred established communication path.

21. The method of claim 17, further comprising:
monitoring a reliability of communication links between a base station and each of the plurality of devices of the wireless network;
wherein:
the network topology is reconfigured as a hierarchical network topology to include a preferred established communication path; and
the base station and each of the plurality of devices reconfigured in the hierarchical network topology communicate at least one of directly and indirectly with each other via the preferred established communication path.
